(19) United States
(12) Patent Application Publication
(10) Pub. No.: US 2004/0261815 A1
(43) Pub. Date: Dec. 30, 2004

(54) Three-step chamber cleaning process for deposition tools

(75) Inventor: Salvatore Pavone, Murphy, TX (US)

Correspondence Address: TEXAS INSTRUMENTS INCORPORATED, P O BOX 655474, M/S 3999, DALLAS, TX, 75265

(73) Assignee: Texas Instruments, Incorporated, Dallas, TX

(21) Appl. No.: 10/607,905

(22) Filed: Jun. 27, 2003

(51) Int. Cl. B08B 9/08

(52) U.S. Cl. 134/1.3; 134/11; 134/25.1; 134/22.1

(57) ABSTRACT

The present invention provides, in one embodiment, a process (100) for cleaning a deposition chamber having multiple substrate stations contained therein. The process (100) includes a first cleaning step (110) that comprises maintaining the deposition chamber at a first pressure while passing a fluorocarbon gas into the deposition chamber. The first cleaning step (100) is conducted until an endpoint is reached. The process also includes a second cleaning step (120) that comprises maintaining the deposition chamber at a second pressure while passing the fluorocarbon gas into the deposition chamber. The process further includes a third cleaning step (130) that comprises maintaining the deposition chamber at a third pressure less than the first and second pressures while passing the fluorocarbon gas into the deposition chamber.

### TECHNICAL FIELD OF THE INVENTION

The present invention is directed in general to the manufacture of integrated circuits, and, more specifically, to an efficient deposition chamber cleaning process for deposition tools.

### BACKGROUND OF THE INVENTION

The formation of uniform layers on semiconductor substrates necessitates that the environment inside deposition chambers of deposition tools, such as chemical vapor deposition (CVD) tools, be continuously monitored and cleaned for residue build-up and contaminants. Consider, for instance, a plasma enhanced chemical vapor deposition (PECVD) tool. Such a tool is commonly employed to deposit a silicon dioxide layer, using tetraethylorthosilicate (TEOS), on a substrate. Silicon dioxide and aluminum fluoride deposits build-up over time on the inside of the deposition chamber. This build-up is highly undesirable because the deposits can flake off and effect the uniformity of silicon dioxide layers being deposited on substrates. To reduce the build-up of such deposits, the chamber is cleaned in situ, typically using a cleaning gas, such as a fluorocarbon gas.

The use of fluorocarbon gas in such processes is advantageous because it can be performed, in situ, that is, in-between chemical deposition procedures being performed on batches of substrates. In situ cleaning procedures, however, are not entirely successful at removing all of the deposits in the chamber. Consequently, after a certain number of hours or days in service, a wipe-clean-out process is required. A wipe-clean-out entails opening up the chamber and mechanically cleaning deposits off of all surfaces inside the chamber. It is desired within the industry to keep the number of wipe-clean-outs to a minimum during the manufacturing process because this necessitates taking the tool out of the fabrication process for several hours, which diminishes both production time, and therefore, product output.

In situ cleaning processes attempt to optimize the balance between several criteria. CVD chamber cleaning gases contribute significantly to the overall material costs in semiconductor manufacturing. In addition, the use of fluorocarbon cleaning gases results in the production of undesirable perfluorocarbon emissions. It is, therefore, desirable to use low amounts of fluorocarbon cleaning gas because this reduces both costs and perfluorocarbon emissions. On the other hand, the in situ cleaning process must still be efficient enough to prevent a decrease in the time before a wipe-clean-out of the chamber is indicated. In addition, the time for the in situ cleaning process itself should not take too long because this reduces the overall throughput of the tool. Previous in situ cleaning processes are not entirely successful in optimizing these criteria, however.

In some instances, for example, an in situ cleaning process is performed after every deposition procedure. Such procedures, however, are practical only for certain types of PECVD tools having a small deposition chamber, for example, a chamber that can accommodate one wafer, and typically used for depositing thin material layers (e.g., less than about 400 Angstroms). In situ cleaning after every deposition is inefficient for tools having larger chambers that accommodate several wafers and typically used for depositing thick material layers (e.g., greater than about 600 Angstroms), because the cleaning cycle time between batches of wafer would be unacceptably long. Moreover, frequent cleaning of the larger chamber would entail increased use of fluorocarbon cleaning gas and increased perfluorocarbon emissions.

Accordingly, what is needed in the art is an efficient in situ cleaning process that reduces the use of fluorocarbon cleaning gases and decreases perfluorocarbon emissions, while not decreasing the time between wipe-clean-out procedures.

### SUMMARY OF THE INVENTION

To address the above-discussed deficiencies of the prior art, the present invention provides a process for cleaning a deposition chamber having multiple substrate stations contained therein. The process includes a first cleaning step that comprises maintaining the deposition chamber at a first pressure while passing a fluorocarbon gas into the deposition chamber. The first cleaning step is conducted until an endpoint is reached. The process also includes a second cleaning step that comprises maintaining the deposition chamber at a second pressure while passing the fluorocarbon gas into the deposition chamber. A third cleaning step that comprises maintaining the deposition chamber at a third pressure less than the first and second pressures while passing the fluorocarbon gas into the deposition chamber is also conducted.

Another embodiment of the present invention is a system for cleaning a deposition chamber having multiple substrate stations contained therein. The system includes a detector configured to monitor by-product deposits in a deposition chamber and a controller. The controller is configured to provide at least three cleaning steps that include the above-described three cleaning steps. The controller is further configured to initiate a transition from one to another of the cleaning steps in response to a signal from the detector.

In yet another embodiment, the present invention provides a method of manufacturing semiconductor devices. The method includes transferring a plurality of substrates into a deposition chamber having multiple substrate stations contained therein and depositing silicon dioxide layers on the substrates. The method also includes cleaning the deposition chamber using an in situ cleaning process when oxide deposits in the deposition chamber reach a predefined thickness. The in situ cleaning process comprises the three cleaning steps discussed above with respect to the first embodiment.

The foregoing has outlined preferred and alternative features of the present invention so that those of ordinary skill in the art may better understand the detailed description of the invention that follows. Additional features of the invention will be described hereinafter that form the subject of the claims of the invention. Those skilled in the art should appreciate that they can readily use the disclosed conception and specific embodiment as a basis for designing or modifying other structures for carrying out the same purposes of the present invention. Those skilled in the art should also realize that such equivalent constructions do not depart from the scope of the invention.

### BRIEF DESCRIPTION OF THE DRAWINGS

The invention is best understood from the following detailed description when read with the accompanying FIGURES. It is emphasized that in accordance with the standard practice in the semiconductor industry, various features may not be drawn to scale. In fact, the dimensions of the various features may be arbitrarily increased or reduced for clarity of discussion. Reference is now made to the following descriptions taken in conjunction with the accompanying drawings, in which:

FIG. 1 illustrate by flow diagram, selected steps of one embodiment of a cleaning process of the present invention;

FIG. 2 presents a block diagram of one embodiment of a system for cleaning a deposition chamber according to the principles of the present invention; and

FIGS. 3A to 3C illustrate cross sectional views of selected steps of an embodiment of a method of manufacturing a semiconductor device according to the principles of the present invention.

### DETAILED DESCRIPTION

The present invention recognizes the advantageous use of a three-step cleaning process using perfluorocarbon gases for cleaning a deposition chamber with multiple substrate stations contained therein. When implementing a cleaning process using perfluorocarbon gases that have higher reactivity than hexafluoroethane, conventional two-step cleaning processes are unacceptable. The cleaning process using these perfluorocarbon gases is further complicated by software limitations that run certain commercial deposition tools. Further, extensive amounts of time are spent calibrating the deposition tool to a particular manufacturing process. Once the tool is purchased and calibrated, manufacturers are extremely reluctant to change the deposition tool because it could mean a complete re-calibration of the tool, which could mean additional process uncertainty. This, of course, is highly undesirable in an industry where production through-put and product quality are paramount. It was found that the software limitations presented a considerable obstacle in getting a deposition chamber cleaned to the extent necessary to maintain desirable intervals between wipe-clean-out procedures. As further illustrated in the example section below, two-step cleaning processes do not adequately remove deposits in chambers having multiple substrate stations, particularly deposits on the showerheads at each station. Consequently, there is poor control of the uniformity of thickness of oxide layers being deposited on substrates. This, in turn, necessitates more frequent wipe-clean-out procedures on the deposition chamber than desired.

The present invention benefits from the realization that introducing a third step into the cleaning process dramatically improves the removal deposits on the showerheads. Improvements in cleaning obtained by the addition of a third cleaning step facilitates the using low quantities of certain perfluorocarbon gases, thereby reducing the costs and perfluorocarbon emissions. Moreover, the time between wipe-clean-out procedures is maintained at acceptable periods.

The use of such a three-step cleaning process is in contrast to traditional cleaning protocols used for deposition chambers having multiple substrate stations. The traditional view is that it is sufficient to introduce a cleaning gas at a high flow rate and chamber pressure in a first cleaning step, and then reduce the chamber pressure and flow rate of the gas in a second cleaning step. Conventional wisdom is that the first step cleans the showerheads and heating block in the chamber, while the second step further cleans the walls of the chamber. The fact that these notions are well entrenched in the field is demonstrated by the fact that certain commercial cleaning systems configured for two-step cleaning processes are not designed to be re-configured to implement a three-step cleaning process.

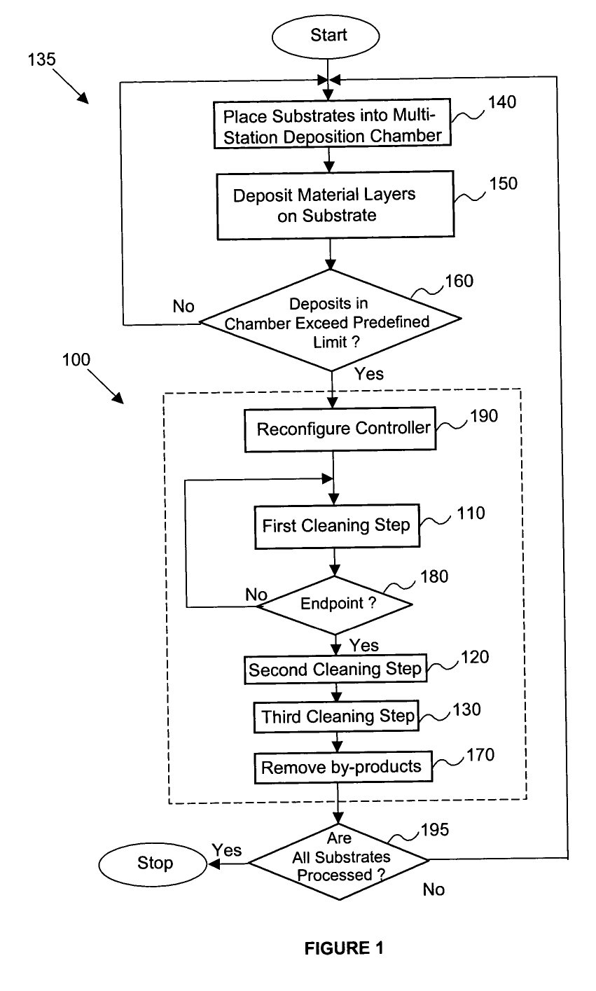

One embodiment of the present invention is a process for cleaning a deposition chamber having multiple substrate stations contained therein. FIG. 1 presents by flow diagram, selected steps of an exemplary cleaning process 100 following the principles of the present invention. In step 110 of the process 100, a first cleaning step is performed. The first cleaning step 110 includes maintaining a deposition chamber at a first pressure while passing a fluorocarbon gas into the deposition chamber. The first cleaning step 110 is conducted until an endpoint is reached, as further discussed below. The process further includes a second cleaning step 120 that includes maintaining the deposition chamber at a second pressure while passing the fluorocarbon gas into the deposition chamber. The process 100 further includes a third cleaning step 130 that includes maintaining the deposition chamber at a third pressure less than the first and second pressures while passing the fluorocarbon gas into the deposition chamber.

Some embodiments of the cleaning process 100 are advantageously integrated as in situ cleaning processes as part of a process 135 for manufacturing semiconductor devices. In such embodiments, the deposition chamber can be part of a conventional CVD tool, such as a plasma enhanced chemical vapor deposition (PECVD) tool. As well understood by those skilled in the art, substrates, such as silicon wafers, are placed into the chamber, in step 140, and one or more material layers are formed on the surface of substrates, in step 150.

The chemical composition of deposits that form on the interior surfaces of the chamber during the manufacturing process 135 depend on the type of deposition procedure being performed and the composition of the chamber. For instance, when silicon oxide, silicon oxynitride, or and silicon nitride layers are formed on a substrate, deposits in aluminum chambers are composed primarily of aluminum and silicon oxides and aluminum and silicon nitrides, respectively. As further discussed below, in certain preferred embodiments, the cleaning process 100 is initiated in step 160, if the deposits in the chamber exceed a predefined limit. In some embodiments the cleaning process is commenced, for example, when the thickness of deposits inside the chamber reach a predefined maximum, such as about 8 micron thick.

One skilled in the art would understand that the fluorocarbon gases serve as etchants that react with the deposits to produce cleaning by-products. Such byproducts can be removed from the chamber in step 170 through gas outlets in the chamber. In certain preferred embodiments of the process 100, it is desirable to use fluorocarbon gases having a higher reactivity or a higher fluorine content than hexafluoroethane. Such characteristics advantageously allow the use of reduced quantities of cleaning gas. In some preferred embodiment, for example, the fluorocarbon gas is selected from the group consisting of: octofluoropentane (C₃F₈); octofluorocyclobutane (cC₄F₈); and octafluorotetrahydrofuran (C₄F₈O).

One skilled in the art would understand that cessation of the first cleaning step 110 may be prompted by any number of endpoints, in step 180. In some embodiments of the process 100, for instance, the endpoint 180 corresponds to a change in the concentration of cleaning by-products, such as an increase in fluorine and decrease carbon monoxide, produced from reactions between the fluorocarbon gas and oxide deposits in the chamber. In certain preferred embodiments, the optical emissions from the by-products in the chamber are monitored during the cleaning process. Changes in the concentrations of fluorine and carbon monoxide can be followed by measuring their optical emission signals at 704 and 483 nanometers, respectively, for example. In some embodiments, therefore, the duration of the first cleaning step 110 depends upon the amount of deposits inside the chamber. For example, in certain embodiments, when there is an 8 micron thick later of oxide deposits inside the chamber at the start of the process 100, the endpoint 180 for the first cleaning step 110 is reached after a period of about 15 to about 20 minutes.

In some embodiments of the process 100, a second cleaning step 120 of short duration is desirable because this reduces the total time spent on cleaning, thereby maintaining the productive throughout of the tool. In particular, it is advantageous to adjust the duration of the second cleaning step so as not to extend beyond the time necessary to ensure adequate cleaning of shower heads in the deposition chamber. In certain preferred embodiments, therefore, the duration of the second cleaning step 120 is for a fixed time and is substantially less (e.g., less than about 25 percent) than the duration of the first cleaning step 110. In some preferred embodiments, for example, the second cleaning step lasts for a period ranging from about 10 to about 240 seconds, and more preferably about 30 seconds.

In still other embodiments of the process 100, it is preferable for the duration of the third cleaning step 130 to be a function of the duration of the first cleaning step 110. In some preferred embodiments, for instance, the third cleaning step 130 lasts for a period equal to fixed time plus a fraction of the duration of the first cleaning step 110. The particular values chosen for the fixed time and fraction depend upon the extent of over-cleaning that is desired. Consider an embodiment of the process where the endpoint 180 is monitored by measured cleaning by-product produced at one location in the chamber. In certain embodiments, it is desirable to extend the duration of the third cleaning step 130 in order to ensure complete cleaning the other locations that are more difficult to clean than the monitored location. As an example, consider an embodiment where the endpoint of the first cleaning step is reached in 15 minutes. In such an embodiment, the duration of the third cleaning step 130 can equal about 375 seconds, that is, 150 seconds plus 25 percent of the duration of the first step 110, (i.e., 225 seconds).

In certain preferred embodiments of the process 100, the second pressure in the second step 120 is greater than the first pressure in the first step 110, because this facilitates the removal of deposits from showerheads or equivalent structures present in the chamber. In other embodiments, however, the second pressure in the second step 120 is less than the first pressure in the first step 110. In some embodiments, the first pressure and second pressures are both between about 3.0 and about 4.0 Torr, while the third pressure is between about 0.5 and about 0.8 Torr. In some preferred embodiments, for example, the first, second and third pressures equal about 3.2, about 3.5 and about 0.6 Torr, respectively.

The flow rate of the fluorocarbon gas passes into the deposition chamber during the cleaning steps 110, 120, 130 strikes a balance between efficient cleaning and reducing the amount of fluorocarbon gas used. In certain preferred embodiments of the process 100, the first cleaning step 110 includes passing the fluorocarbon gas into the deposition chamber at a first flow rate between about 600 and about 1200 sccm, and more preferably about 850 sccm. In other preferred embodiments, the second cleaning step 120 includes passing the fluorocarbon gas into the deposition chamber at a second flow rate substantially equal to the first flow rate. In still other preferred embodiments, the third cleaning step 130 includes passing the fluorocarbon gas into the deposition chamber at a third flow rate that is less, and more preferably substantially less (e.g., about 60 percent less), than the first and second flow rate. In some preferred embodiments, for example, the third flow rate is between about 300 and about 1200 sccm, and more preferably about 500 sccm.

Certain preferred embodiments of the cleaning process 100 further include passing oxygen gas (O₂) into the deposition chamber during the cleaning steps 110, 120, 130. A cleaning gas that comprises a mixture of oxygen and fluorocarbon gas has increased reactivity as compared to a fluorocarbon alone, and therefore the total duration needed for cleaning is reduced. In some embodiments, the reactivity of the cleaning gas mixture is increased by using an oxygen-rich cleaning gas mixture. For instance, the ratio of the flow rate of oxygen to the flow rate of fluorocarbon gas is maintained between about 2:1 and about 4:1 during the cleaning steps 110, 120, 130. In embodiments using the above-cited flow rates of fluorocarbons, for example, the flow rate of oxygen gas into the deposition chamber is between about 1900 and about 3000 sccm during the first and second cleaning steps 110, 120, and between about 100 and about 2000 sccm during the third cleaning step 130.

Still other preferred embodiments of the cleaning process 100 further include the generation of a plasma, such as a radio frequency plasma, during the cleaning steps 110, 120, 130. In the presence of a plasma, the above-described cleaning gases are more reactive and therefore, the total time necessary for cleaning is advantageously reduced. In some embodiments, a radio frequency power setting of between about 2000 and about 4000 Watts is used during any of the first, second and third cleaning steps, 110, 120, 130. In some preferred embodiments, the radio frequency power setting during the second cleaning step 120 is greater than that used in the first cleaning step 110. In other preferred embodiments, the radio frequency power setting during the first cleaning step 110 is greater than that used in the third cleaning step 130. In some embodiments, for example, the radio frequency power settings during the first, second and third cleaning steps 110, 120, 130, are about 3000, 3500 and 2500 Watts, respectively.

In certain preferred embodiments of the process 100, as illustrated in FIG. 1, the first cleaning step 110 is performed before the second cleaning step 120, and the third cleaning step 130 is performed after the second cleaning step. This particular sequence of cleaning steps can be advantageous in embodiments where the duration of the third cleaning step 130 is a function of the duration of the first cleaning step 110, or the first and second cleaning steps 110, 120. This sequence can also be advantageous in embodiments where the flow rate of one or both of the fluorocarbon or oxygen gases are kept the same in the first and second cleaning steps 110, 120, and then decreased in the third cleaning step 130.

In other embodiments of the process 100, however, the sequence of cleaning steps can be different. In some embodiments, for example, the first cleaning step 110 is performed before the third cleaning step 130, and the second cleaning step 120 is performed after the third cleaning step 130. In still other embodiments, the second cleaning step 120 is performed before the first cleaning step 110, and the third cleaning step 130 is performed after the first cleaning step 110.

Other embodiments of the process 100 include a step 190 of modifying a controller to provide a three-step cleaning process controller. Such embodiments are applicable, for instance, where the deposition chamber originally had a controller configured to conduct a two-step cleaning process. Such embodiments of the process 100 further include implementing the three-step cleaning process controller to conduct the first, second and third cleaning steps 110, 120, 130. In step 195, it is determined if the manufacturing process 135 should be stopped, or continued by repeating steps 140 and 150, if additional substrates (e.g., wafers) are to be processed.

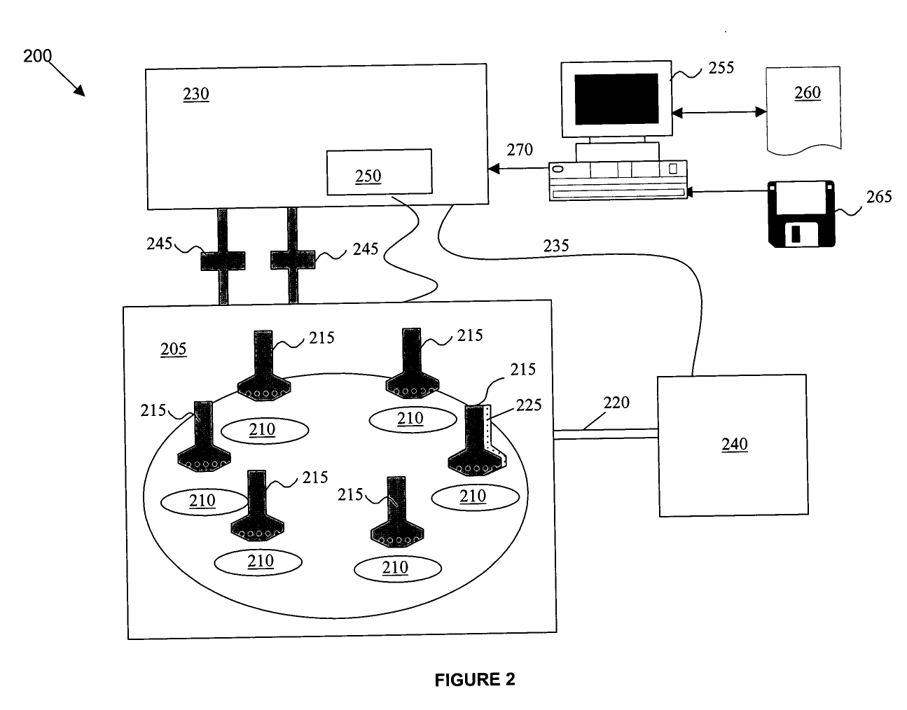

Yet another embodiment of the present invention is illustrated in the block diagram of FIG. 2, a system 200 for cleaning a deposition chamber 205. In some embodiments, the system 200 includes a deposition chamber 205 having multiple substrate stations 210 contained therein. In certain preferred embodiments, each substrate station 210 has a showerhead 215. The system 200 further includes a detector 220 configured to monitor cleaning by-products of deposits 225 in the deposition chamber 205. The system 200 also includes a controller 230 configured to provide at least three cleaning steps and to initiate a transition from one to another of the cleaning steps in response to a signal 235 from the detector 220. Any of the above-described embodiments of the three-step cleaning process of the present invention, illustrated in FIG. 1 and discussed above, can be used in the system 200.

In some preferred embodiments, the detector 220 sends the signal 235 to the controller 230 when cleaning by-products of the deposits 225 change by a predefined amount. In some embodiments, for example, the detector 220 includes an optical spectrometer 240 configured to measure optical emissions from cleaning by-products produced from a reaction between the deposits 225 and the fluorocarbon gas. In certain preferred embodiments, the optical spectrometer 240 measures optical emissions from one or more of fluorine and carbon monoxide at wavelengths of about 704 and 483 nanometers, respectively.

In particular embodiments of the system 200, where the controller 230 was originally configured to conduct a two-step cleaning process, the controller 230 is modified to provide a three-step cleaning process controller 230. Such embodiments of the system 200 further include using the three-step cleaning process controller 230 to conduct the first, second and third cleaning steps described above and illustrated in FIG. 1. In yet other embodiments, the controller 230 further includes one or more valves 245 for introducing fluorocarbon and other gases into said deposition chamber 205. For example, in some preferred embodiments, the controller 230 is configured to actuate the flow of cleaning gases, such as octofloropentane and oxygen through showerheads 215 inside the deposition chamber 205. In other preferred embodiments, the controller 230 is also configured to regulate a radio frequency power source 250 used to generate a plasma inside the deposition chamber 205 during the cleaning process.

Still other embodiments of the system 200 further include a computer 255 configured to read a data file 260 having settings for the at least three cleaning steps used by the controller 230. Such setting can include parameters such as gas flow rates, radio frequency power setting, chamber pressures and the durations of particular settings. Other embodiments of the system 200 also include a computer readable media 265 capable of causing the computer 255 to produce a control signal 270 that causes the controller 230 to initiate three-step cleaning process, transition from one cleaning step to the next, or to cease the cleaning cycle. The computer readable media 265 can comprise any computer storage tools including, but not limited to, hard disks, CDs, floppy disks, and memory or firmware.

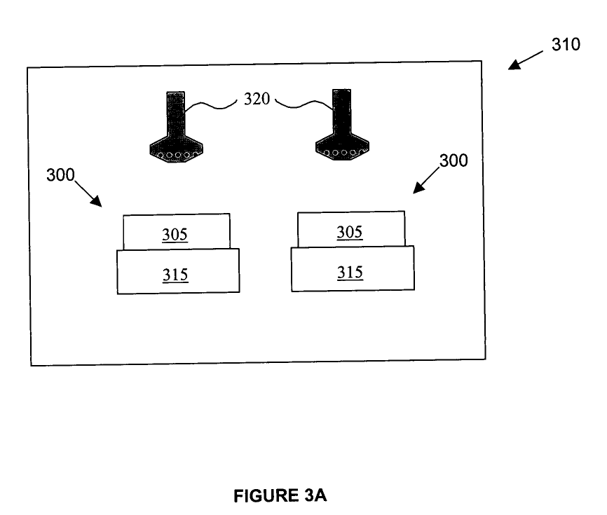

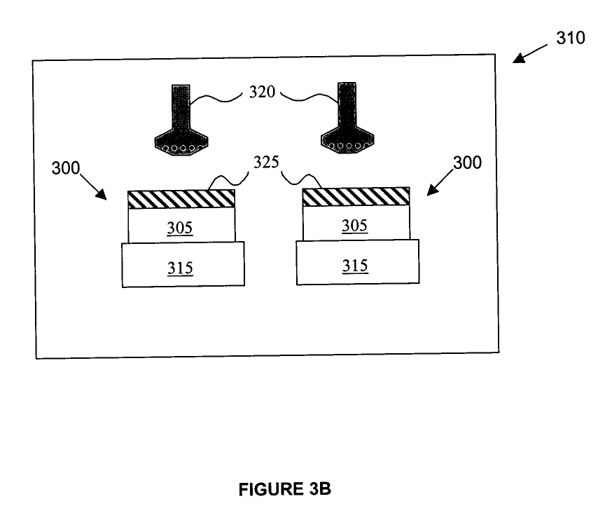

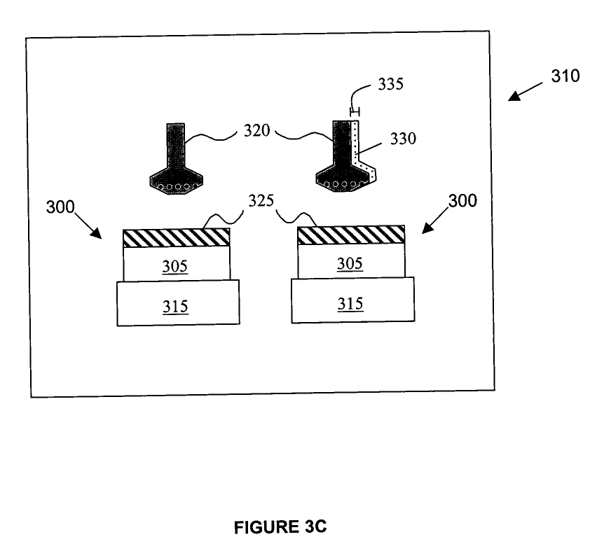

Yet another embodiment of the present invention is a method of manufacturing semiconductor devices. FIGS. 3A to 3C illustrate cross sectional views of selected steps of an embodiment of a method of manufacturing a semiconductor device 300 according to the principles of the present invention. Turning first to FIG. 3A, the method includes transferring a plurality of substrates 305 into a deposition chamber 310 having multiple substrate stations 315 contained therein. Preferably the deposition chamber includes a plurality of showerheads 320 at each of the substrate stations 315.

As shown in FIG. 3B, material layers 325 are deposited on the substrates 305. In certain embodiments of the method 300, the material layers 325 are inter-level, or in other embodiments, a top level, dielectric layers 325. In certain processes, for instance, the material layers 325 may be silicon dioxide, silicon nitride or silicon oxynitride. In certain preferred embodiments the deposition is carried out using conventional CVD or PECVD procedures, well known to those skilled in the art.

As shown in FIG. 3C, the method 300 further includes cleaning the deposition chamber 310 using an in situ cleaning process when deposits 330 in the deposition chamber 310 reach a predefined thickness 335. The in situ cleaning process may comprise any of the previously described cleaning processes of the present invention. In some preferred embodiments, the predefined thickness 335 is estimated from a rate of depositing the material layers 325 on the substrates 305. For example, in some embodiments using a TEOS process to deposit silicon dioxide layers 325 on silicon wafer substrates 305, the predefined thickness 335 is at least about 8 microns.

In certain preferred embodiments, the method 300 further includes performing a wipe-cleaning-out of the deposition chamber 310 when a variation in thickness of the material layers 325 exceeds a predefined limit. For instance, in some embodiments, a wipe-clean-out procedure is indicated when the variation in thickness 335 of the material layer 325 deposition on the first to the last wafer substrate 305 in a batch of substrates 305 is greater than about ±5 percent of a target thickness. Consider, for example, an embodiment of the method 300, where silicon dioxide layers 325 having a target thickness of 12,000 Angstroms are desired. If the average thickness of the silicon dioxide layer 325 deposited from the first to the last in a batch of 24 wafer substrate 305 varies by more than ±500 Angstroms, a wipe-clean-out is performed. In certain preferred embodiments of method 300 a period until the wipe-clean-out procedure, or between successive wipe-clean-out procedures, is at least about 50 deposition hours.

Having described the present invention, it is believed that the same will become even more apparent by reference to the following examples. It will be appreciated that the examples are presented solely for the purpose of illustration and should not be construed as limiting the invention. For example, although the experiments described below may be carried out in a laboratory setting, one skilled in the art could adjust specific numbers, dimensions and quantities up to appropriate values for a full-scale production plant setting.

### EXAMPLES

The following examples are presented to illustrate the effectiveness of the three-step cleaning process of the present invention as compared to a conventional two-step cleaning process. A two-chambered PECVD tool (Novellus Sequel System, Novellus Systems, Inc., San Jose, Calif.) having six stations per chamber was used. For test purposes, an about 12,000 Angstrom thick layers of silicon dioxide was deposited on silicon wafers using a conventional TEOS process. The tool was configured to run an intermittent in situ cleaning process when the total thickness of oxide deposited on the surfaces inside the chamber was greater than about 8 microns. The thickness of the oxide deposit was estimated based on the deposition rate parameters used in the TEOS process.

The tool was also configured to run the TEOS PECVD process for a maximum period of fifty hours of TEOS deposition, after which a wipe-clean-out process was performed on the deposition chamber. The need for a wipe-clean-out process early than this is indicated, however, if the variation in the thickness of silicon dioxide layers being deposited on silicon wafers varied by more than a predefined limit across batches of 24 wafers. Typically, the thickness of the first and last wafer in each batch was monitored using conventional reflectometry or ellipsometry procedures. When the variability in thickness exceeded the predefined limit of about 5 percent a wipe-clean-out is performed.

Numerous cleaning protocols were tested over the course of several days. For illustrative purposes, two in situ cleaning processes are compared: a conventional two-step cleaning process and a three-step cleaning process of the present invention. The flow rate of C₃F₈ (FR—C₃F₈) and O₂ (FR—O₂); pressure inside the chamber (Pressure); and the radio-frequency power used (RF-power) during the cleaning steps and the duration of the steps (time) are summarized in TABLE 1.

TABLE 1

| | | |
|---|---|---|
| Step 1 | Step 2 | Step 3 |

Two-Step Cleaning Process

| | | |
|---|---|---|
| FR-C₃F₈ (sccm) | 900 | 500 |
| FR-O₂ (sccm) | 2400 | 1600 |
| Pressure (Torr) | 3.2 | 0.6 |
| RF-power (Watts) | 3000 | 2500 |

Three-Step Cleaning Process

| | | | |
|---|---|---|---|
| FR-C₃F₈ (sccm) | 900 | 900 | 500 |
| FR-O₂ (sccm) | 2400 | 2400 | 1600 |
| Pressure (Torr) | 3.2 | 3.5 | 0.6 |
| RF-power (Watts) | 3000 | 3500 | 2500 |

The duration of Step 1 in either of the cleaning processes depended upon the detection of an endpoint. An endpoint detection module in the tool monitored levels of fluorine (F) and carbon monoxide (CO) by measuring optical emissions at 704 and 483 nanometers, respectively. Optical emissions were monitored through a quartz window built into one of the sides of the chamber. Typically the endpoint was reached after 15 to 20 minutes, depending on the amount of oxide deposited inside the chamber. Step 2 in the two-step process and Step 3 in the three-step process both had a duration of 150 seconds plus 25 percent of the duration of Step 1. Step 2 in the three-step process had a duration of 30 seconds.

Exemplary results obtained from three trial runs using the two-step cleaning process are presented in TABLE 2. When running the two-step cleaning process, summarized in TABLE 1, thickness variations across batches of wafer indicating that a wipe-clean-out procedure was needed between about 15 and about 18 hours before the 50 hour maximum period for running the TEOS PECVD process. The deposition chamber was inspected before doing the wipe-clean-out procedure. Two-step processes did not adequately remove deposition particles in the chamber, particularly deposits on the sides of the showerheads. The build-up of such deposits results in unacceptable thickness variations of oxide layers being deposited on wafer substrates. In certain instances, the deposits flaked off the shower head and land on the surface of wafer substrates. In other instances, as deposits build up on the side of the showerheads, the deposition rate of oxide layers was reduced. Moreover, simply increasing the pressure inside the chamber or flow rate of fluorocarbon and oxygen gas during the first step did not reduce the build up of deposits on the sides of the showerheads.

TABLE 2

| | Deposition Hours Until |
|---|---|
| Trial | Wipe-Clean-Out Required |
| 1 | 35 |
| 2 | 32 |
| 3 | 33 |

To circumvent these problems, a third-cleaning step was introduced. It was hypothesized that a third step having a high chamber pressure or high flow rate of fluorocarbon gas would prevent the build-up of deposits of the sides of the showerheads. To implement a three-step cleaning process on the Novellus Sequel System, it was necessary to reconfigure the software program that controls the two-step cleaning process originally provided with the system, into a three-step process. In particular, new parameters to control O₂ flow, chamber pressure, RF power, fluorocarbon gas flow rate and duration of the third step were created. An example of a portion of a reconfigured program containing the added third step, designated as “Mid,” is presented in TABLE 3.

TABLE 3

| | | |
|---|---|---|
| Device | Description | Action |

STEP 10 of 22: (Mid Turn On Generators)
EXECUTE: hen3ry (timeout, 5 sec)

| | | |
|---|---|---|
| gen1 | HF RF Generator | SetGenPower(0) |
| gen2 | LF RF Generator | SetGenPower(0) |
| gen1 | HF RF Generator | TurnOnGen |
| gen2 | LF RF Generator | TurnOnGen |
| gen1 | HF RF Generator | IsGenPowered |
| gen2 | LF RF Generator | IsGenPowered |

ENDING CONDITIONAL: (loop delay, 100 msec)

| | |
|---|---|
| OBJC | cdk2 |

STEP 11 of 22: (Mid Prepare For Clean)
EXECUTE: hen3ry (timeout, 90 sec)

| | | |
|---|---|---|
| gen1 | HF RF Generator | TurnOnGen |
| vl07 | MB Gas Inlets | Openvalve |
| vl46 | MB Upper | OpenValve |
| vl24 | MB Lower | OpenValve |
| mfc9 | Freon 116 | SetFlow(mC2F) |
| mfc8 | Oxygen MFC | SetFlow(mO2) |
| adp1 | Adaptor Serial Interface | SetAdaptorPressure(mPrs) |

ENDING CONDITIONAL: (loop delay, 100 msec)

| | | |
|---|---|---|
| mfc9 | Freon 116 | IsFlowInSpec(10) AND |
| mfc8 | Oxygen MFC | IsFlowInSpec(10) AND |
| adp1 | Adaptor Serial Interface | IsPressureInPercent(10) AND |
| OBJC | | cdk2 |

STEP 12 of 22: (Mid Step RF to 800 W)
EXECUTE: hen3ry (timeout, 60 sec)

| | | |
|---|---|---|
| gen1 | HF RF Generator | SetGenPower(800) |
| clk2 | SetTicks(2) | |

ENDING CONDITIONAL: (loop delay, 100 msec)

| | | |
|---|---|---|
| gen1 | HF RF Generator | IsGenPowerInSpec(10, 70) |
| | | AND |
| clk2 | | NOT IsTicksExpired AND |
| OBJC | | cdk2 |

STEP 13 of 22: (Mid Step RF to 2000 W)
EXECUTE: hen3ry (timeout, 60 sec)

| | | |
|---|---|---|
| gen1 | HF RF Generator | SetGenPower(2000) |
| clk2 | | SetTicks(2) |

ENDING CONDITIONAL: (loop delay, 100 msec)

| | | |
|---|---|---|
| gen1 | HF RF Generator | IsGenPowerInSpec(10, 70) AND |
| clk2 | | NOT IsTicksExpired AND |
| OBJC | | cdk2 |

STEP 14 of 22: (Mid Clean Chamber)
EXECUTE: hen3ry (timeout, 160 sec)

| | | |
|---|---|---|
| gen1 | HF RF Generator | SetGenPower(mHRF) |
| clk2 | | SetTicks(mTim) |

ENDING CONDITIONAL: (loop delay, 100 msec)

| | | |
|---|---|---|
| gen1 | HF RF Generator | IsGenPowerInSpec(10, 70) AND |
| clk2 | | NOT IsTicksExpired AND |
| OBJC | | cdk2 |

STEP 15 of 22: (Mid RF Off and Pump to base)
EXECUTE: hen3ry (timeout, 90 sec)

| | | |
|---|---|---|
| gen1 | HF RF Generator | SetGenPower(0) |
| mfc9 | Freon 116 | SetFlow(0) |
| mfc8 | Oxygen MFC | SetFlow(0) |
| vl07 | MB Gas Inlets | CloseValve |
| vl24 | MB Lower | CloseValve |
| vl46 | MB Upper | CloseValve |
| adp1 | Adaptor Serial Interface | SetAdaptorAngle(90) |

ENDING CONDITIONAL: (loop delay, 100 msec)

| | | |
|---|---|---|
| ga01 | Chamber Mano Pressure | IsGaugeInRange(−1, 0.1) AND |
| OBJC | | cdk2 |

The results obtained for three trials using a three-step cleaning process, is presented in TABLE 4. Surprisingly, when running a three-step cleaning process, such as that summarized in TABLE 1, thickness variations in an oxide layer deposited on different batches of wafers did not exceed the predefined limit, and therefore an early wipe-clean-out procedure was not required. Moreover, inspection of the chamber prior to a wipe-clean-out revealed that there was no build up to deposits on the sides of the shower heads, unlike that observed when using the two-step cleaning process.

TABLE 4

| | Deposition Hours Until |
|---|---|
| Trial | Wipe-Clean-Out Required |
| 1 | 50 |
| 2 | 50 |
| 3 | 50 |

Although the present invention has been described in detail, one of ordinary skill in the art should understand that they can make various changes, substitutions and alterations herein without departing from the scope of the invention.

What is claimed is:

1. A process for cleaning a deposition chamber having multiple substrate stations contained therein, comprising:
a first cleaning step that includes maintaining a deposition chamber at a first pressure while passing a fluorocarbon gas into said deposition chamber, said first cleaning step conducted until an endpoint is reached;
a second cleaning step that includes maintaining said deposition chamber at a second pressure while passing said fluorocarbon gas into said deposition chamber; and
a third cleaning step that includes maintaining said deposition chamber at a third pressure less than said first and second pressures while passing said fluorocarbon gas into said deposition chamber.

2. The process as recited in claim 1, wherein said fluorocarbon gas is selected from the group consisting of:
octofluoropentane (C₃F₈);
octofluorocyclobutane (cC₄F₈); and
octafluorotetrahydrofuran (C₄F₈O).

3. The process as recited in claim 1, wherein said endpoint is determined by monitoring optical emissions from fluorine and carbon monoxide.

4. The process as recited in claim 1, wherein a duration of said second cleaning step is substantially less than a duration of said first cleaning step and a duration of said third cleaning step is a function of said duration of said first cleaning step.

5. The process as recited in claim 1, wherein said second pressure is greater than said first pressure.

6. The process as recited in claim 1, wherein said first and second cleaning step further include passing said fluorocarbon gas into said deposition chamber at substantially equal flow rates of between about 600 and about 1200 sccm, and said third cleaning step further includes passing said fluorocarbon gas into said deposition chamber at a third flow rate of between about 300 and about 1200 sccm.

7. The process as recited in claim 1, wherein said first cleaning step is performed before said second cleaning step, and said third cleaning step is performed after said second cleaning step.

8. The process as recited in claim 1 wherein said deposition chamber includes a controller configured to conduct a two-step cleaning process and said controller is modified to provide a three-step cleaning process controller and said process further includes implementing said three-step cleaning process controller to conduct said first, second and third cleaning steps.

9. A system for cleaning a deposition chamber having multiple substrate stations contained therein, comprising:
a detector configured to monitor cleaning by-products in a deposition chamber; and
a controller configured to provide at least three cleaning steps and to initiate a transition from one to another of said cleaning steps in response to a signal from said detector, said at least three cleaning steps comprising:
a first cleaning step that includes maintaining a deposition chamber at a first pressure while passing a fluorocarbon gas into said deposition chamber, said first cleaning step conducted until an endpoint is reached;
a second cleaning step that includes maintaining said deposition chamber at a second pressure while passing said fluorocarbon gas into said deposition chamber; and
a third cleaning step that includes maintaining said deposition chamber at a third pressure less than said first and second pressures while passing said fluorocarbon gas into said deposition chamber.

10. The system as recited in claim 9, wherein said second pressure is greater than said first pressure.

11. The system as recited in claim 9, wherein said detector indicates that said cleaning by-products change by a predefined amount.

12. The system as recited in claim 9, wherein said detector includes an optical spectrometer configured to measure optical emissions from by-products produced from a reaction between said deposits and said fluorocarbon gas.

13. The system as recited in claim 9 wherein said controller is configured to conduct a two-step cleaning process and said controller is modified to provide a three-step cleaning process controller, wherein said three-step cleaning process controller is configured to implement said three-step cleaning process controller to conduct said first, second and third cleaning steps.

14. The system as recited in claim 9, wherein said controller includes one or more valves for introducing fluorocarbon gases into said deposition chamber.

15. The system as recited in claim 9, wherein said controller further includes:
a computer configured to read a data file having settings for said at least three cleaning steps; and
a computer readable media capable of causing said computer to produce said signal to initiate said transition.

16. A method of manufacturing semiconductor devices comprising:
transferring a plurality of substrates into a deposition chamber having multiple substrate stations contained therein and depositing material layers on said substrates; and
cleaning said deposition chamber using an in situ cleaning process when deposits in said deposition chamber reaches a predefined thickness, said in situ cleaning process comprising:
a first cleaning step that includes maintaining said deposition chamber at a first pressure while passing a fluorocarbon gas into said deposition chamber, said first cleaning step conducted until an endpoint is reached;
a second cleaning step that includes maintaining said deposition chamber at a second pressure while passing said fluorocarbon gas into said deposition chamber; and
a third cleaning step that includes maintaining said deposition chamber at a third pressure less than said first and second pressures while passing said fluorocarbon gas into said deposition chamber.

17. The method recited in claim 16, wherein said predefined thickness is estimated from a rate of depositing said material layers on said substrates.

18. The method recited in claim 16, further includes performing a wipe-cleaning-out of said deposition chamber when a variation in thickness of said material layer exceeds a predefined limit.

19. The method recited in claim 18, wherein said predefined limit is about ±5 percent of a target thickness.

20. The method recited in claim 18, wherein a period until said wipe-clean-out process is at least about 50 deposition hours.
